(19) United States
(12) Patent Application Publication
(10) Pub. No.: US 2022/0343875 A1
(43) Pub. Date: Oct. 27, 2022

(54) ELECTRONIC DEVICE, ELECTRONIC SYSTEM AND CONTROL METHOD

(71) Applicants: Chia-Yu Wu, Hsinchu County (TW); Kuan-Chang Huang, Taichung City (TW); Jiun-Shiue Huang, Taipei City (TW); Lee-Chun Guo, Hsinchu City (TW); Chao-Hsun Huang, Keelung City (TW); Chuan-Hou Hsu, Hsinchu County (TW); Yao-Te Fang, Hsinchu City (TW)

(72) Inventors: Chia-Yu Wu, Hsinchu County (TW); Kuan-Chang Huang, Taichung City (TW); Jiun-Shiue Huang, Taipei City (TW); Lee-Chun Guo, Hsinchu City (TW); Chao-Hsun Huang, Keelung City (TW); Chuan-Hou Hsu, Hsinchu County (TW); Yao-Te Fang, Hsinchu City (TW)

(73) Assignee: ITE Tech. Inc., Hsinchu (TW)

(21) Appl. No.: 17/483,831

(22) Filed: Sep. 24, 2021

(30) Foreign Application Priority Data
Apr. 26, 2021 (TW) 110114894

(51) Int. Cl. G09G 5/00; H04N 7/01

(52) U.S. Cl. CPC G09G 5/005; G09G 5/006; H04N 7/0122; G09G 2354/00; G09G 2358/00; G09G 2370/16; G09G 2370/025; G09G 2360/02

(57) ABSTRACT

An electronic device, an electronic system, and a control method are provided. The electronic device includes a display, a memory, and a processor. The memory stores an audiovisual module and a control module. The processor receives initial image information from an external electronic device through a bridge device. The processor is coupled to the display and the memory. The processor executes the audiovisual module to transform the initial image information with a first image format into transformed image information with a second image format, which is compatible to the display. The processor controls the display to display according to the transformed image information. The processor executes the control module to receive a control signal for operating the transformed image information, and provide the control signal to the external electronic device through the bridge device.

### CROSS-REFERENCE TO RELATED APPLICATION

This application claims the priority benefit of Taiwan application serial no. 110114894, filed on Apr. 26, 2021. The entirety of the above-mentioned patent application is hereby incorporated by reference herein and made a part of this specification.

### BACKGROUND

### Technical Field

The disclosure relates to a device, a system, and a method, and more particularly relates to an electronic device, an electronic system, and a control method.

### Description of Related Art

In the existing technology, electronic devices have quite limited functions in sharing images, controlling functions, and transmitting data with/to other electronic devices. The existing software and hardware products usually only provide a single function.

For example, when an electronic device shares an image with another electronic device, the another electronic device cannot control the electronic device that shares the image. For another example, when image sharing and function controlling are implemented by software, the electronic device that shares the image needs to enable the security permission to enable the image sharing function. As a result, the electronic device may face information security risks. In addition, in order to acquire audio from Android phones, the devices need to be in the same WiFi domain. Therefore, it is inconvenient for users to use the existing technology to share video, audio, and control signals between different electronic devices.

### SUMMARY

The disclosure provides an electronic device, an electronic system, and a control method, which are convenient for a user to operate for acquiring an image and sharing a control signal.

An electronic device according to the disclosure includes a display, a memory, and a processor. The memory stores an audiovisual module and a control module. The processor receives initial image information from an external electronic device through a bridge device. The processor is coupled to the display and the memory. The processor executes the audiovisual module to transform the initial image information with a first image format into transformed image information with a second image format. The processor controls the display display according to the transformed image information, and the second image format is compatible to the display. The processor executes the control module to receive a control signal for operating the transformed image information, and provide the control signal to the external electronic device through the bridge device.

An electronic system according to the disclosure includes a bridge device, a first electronic device, and a second electronic device. The first electronic device is coupled to the bridge device. The first electronic device receives initial image information through the bridge device. The first electronic device includes a display, a memory, and a processor. The memory stores a first audiovisual module and a control module. The processor is coupled to the display and the memory. The second electronic device is coupled to the bridge device. The second electronic device outputs the initial image information to the bridge device. The processor of the first electronic device executes the first audiovisual module to transform the initial image information with a first image format into transformed image information with a second image format. The processor controls the display to display according to the transformed image information, and the second image format is compatible to the display. The processor of the first electronic device executes the control module to receive a control signal for operating the transformed image information, and provide the control signal to the second electronic device through the bridge device.

A control method according to the disclosure is adapted for controlling an electronic device to display. The control method includes: receiving initial image information from an external electronic device through a bridge device; executing an audiovisual module by the electronic device to transform the initial image information with a first image format into transformed image information with a second image format, and enabling a display of the electronic device to display according to the transformed image information, the second image format being compatible to the display; and executing a control module by the electronic device receive a control signal for operating the transformed image information, and providing the control signal to the external electronic device through the bridge device.

Based on the above, the electronic device, electronic system, and control method according to the disclosure allow the user to share an image and provide a control signal without changing the user setting of the electronic device, thereby improving the convenience in operation.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of an electronic system according to an embodiment of the disclosure.

FIG. 2A is a flowchart of a control method according to an embodiment of the

### DISCLOSURE

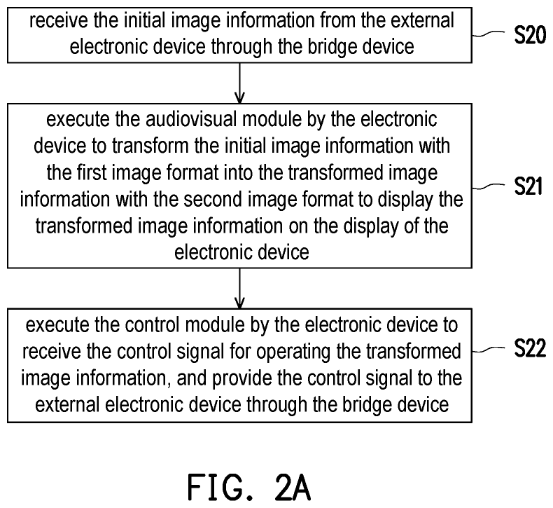

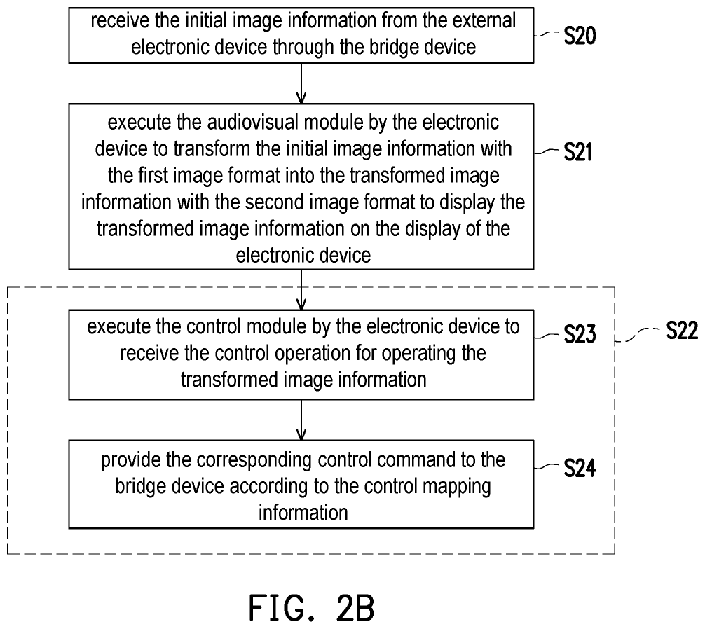

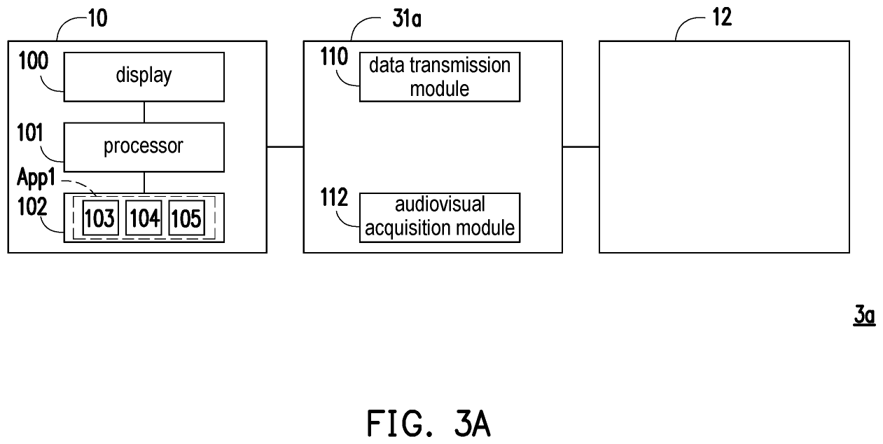

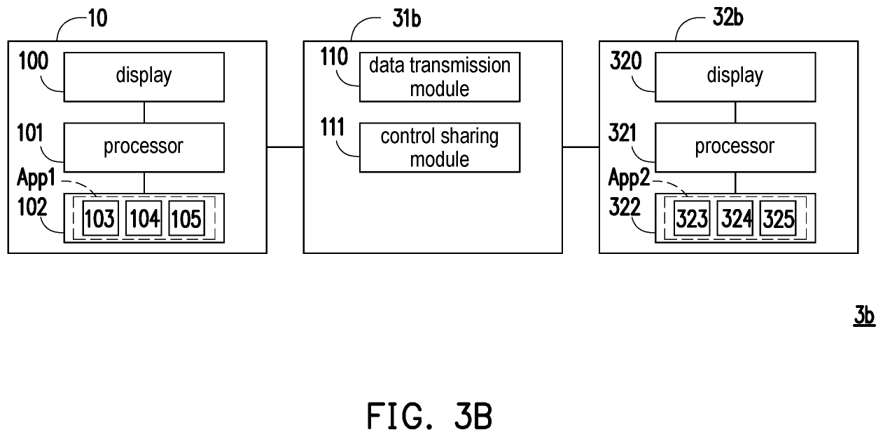

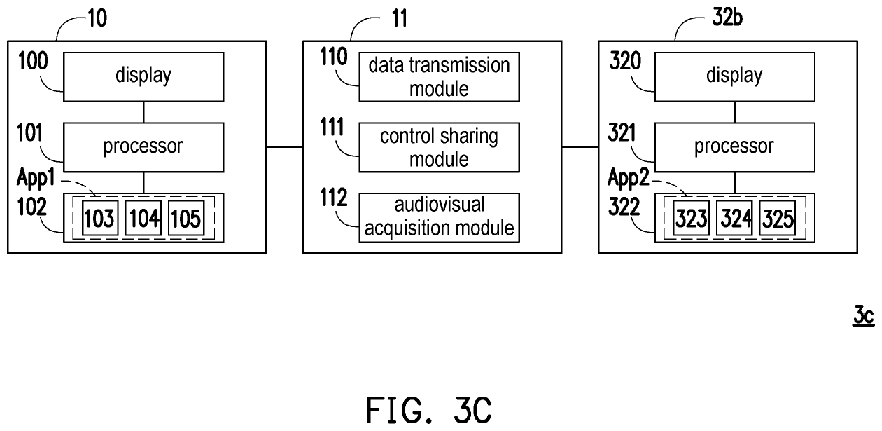

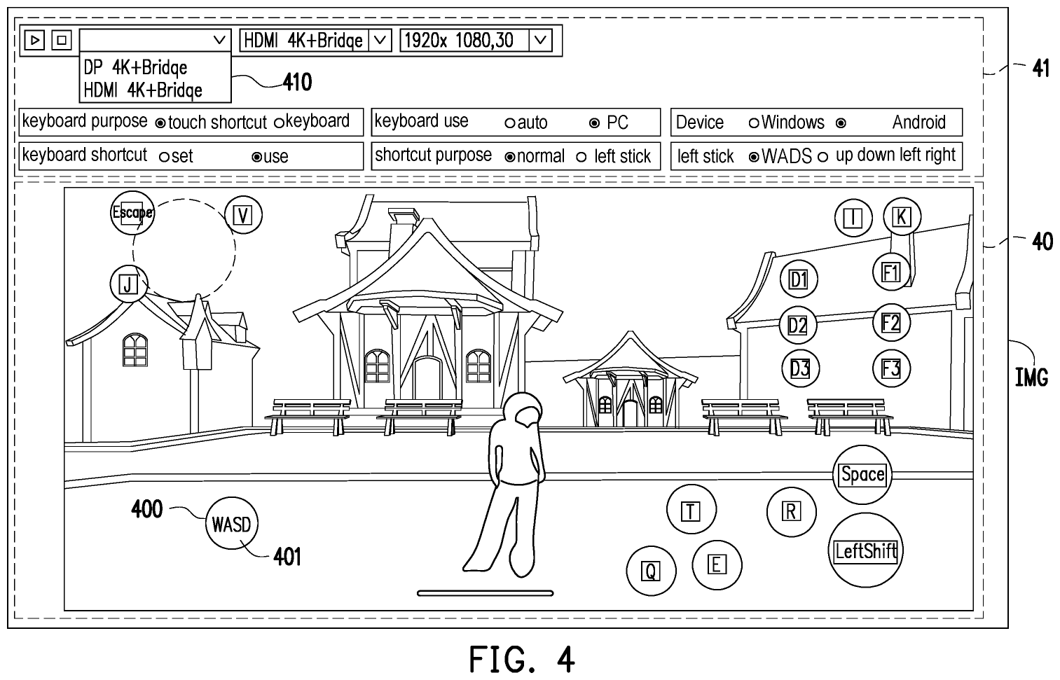

FIG. 2B is a flowchart of a control method according to an embodiment of the disclosure.

FIG. 3A is a schematic diagram of an electronic system according to an embodiment of the disclosure.

FIG. 3B is a schematic diagram of an electronic system according to an embodiment of the disclosure.

FIG. 3C is a schematic diagram of an electronic system according to an embodiment of the disclosure.

FIG. 4 is a schematic diagram of a screen displayed by a display according to transformed image information according to an embodiment of the disclosure.

### DETAILED DESCRIPTION OF DISCLOSED EMBODIMENTS

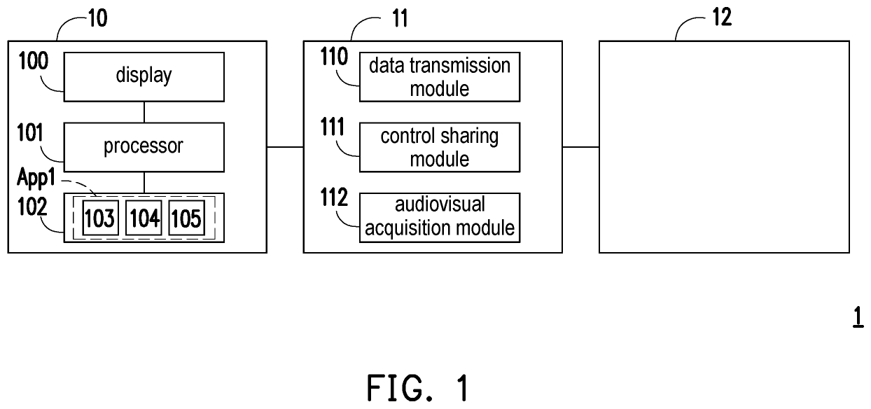

FIG. 1 is a schematic diagram of an electronic system 1 according to an embodiment of the disclosure. The electronic system 1 includes an electronic device 10, a bridge device 11, and an electronic device 12. As a whole, the bridge device 11 is coupled between the electronic devices 10 and 12. The electronic device 12 may provide initial image information. The electronic device 10 may receive the initial image information through the bridge device 11, and perform appropriate format transformation on the initial image information to display transformed image information on the electronic device 10. Furthermore, according to the transformed image information displayed by the electronic device 10, the user may also input a control signal to the electronic device 10 to operate the electronic device 12.

The electronic device 12 may have a function of capturing image information or displaying image information. The electronic device 12 may transmit an image captured or displayed by the electronic device 12 itself as the initial image information. For example, the electronic device 12 may be a desktop computer, a laptop tablet computer, a network computer, a workstation, a personal digital assistant (PDA), a personal computer (PC), a scanner, a mobile phone, a smart phone, an electronic book, a camera, a video camera, a smart TV, a projector, a TV box, etc., but not limited thereto.

In an embodiment, the electronic device 12 may have an image output port for directly outputting an image. For example, the image output port of the electronic device 12 may be a Displayport output port, a high definition multimedia interface (HDMI) output port, a mobile high-definition link (MHL) output port, a digital visual interface (DVI), a dual port D-sub connector (D-sub) connection port, etc., but not limited thereto.

The bridge device 11 is coupled between the electronic device 10 and the electronic device 12. In an embodiment, the bridge device 11 is coupled to the image output port of the electronic device 12. The bridge device 11 may acquire the initial image information from the image output port of the electronic device 12. Furthermore, the bridge device 11 also stores a data transmission module 110, a control sharing module 111, and an audiovisual acquisition module 112. The bridge device 11 may execute the data transmission module 110, the control sharing module 111, and/or the audiovisual acquisition module 112 to transmit data between the electronic devices 10 and 12, and share the control signal provided by the user on the electronic device 10 with the electronic device 12.

The bridge device 11 may be connected to the electronic device 10 and the electronic device 12 in a wired or wireless manner. For example, a wired connection interface may include a world wide web (WWW) interface, a local area network (LAN) interface, a universal serial bus (USB) interface, and/or other wired communication interfaces. A wireless connection interface may include a WiFi communication interface, a Bluetooth communication interface, an infrared radiation (IR) communication interface, a ZigBee communication interface, and/or other wireless communication interfaces, but not limited thereto.

In detail, the bridge device 11 may execute the data transmission module 110 to transmit data between the electronic devices 10 and 12, and the transmission may be unidirectional and/or bidirectional. In addition, the bridge device 11 may execute the control sharing module 111 to provide the control signal provided by the electronic device 10 to the electronic device 12. Finally, the bridge device 11 may execute the audiovisual acquisition module 112 to acquire an image and/or an audio signal from the electronic device 12 and provide the same to the electronic device 10. In this way, the bridge device 11 may execute the audiovisual acquisition module 112 to provide the initial image information from the electronic device 12 to the electronic device 10.

The electronic device 10 is coupled to the bridge device 11, and the electronic device may receive the initial image information provided by the electronic device 12 through the bridge device 11. The electronic device 10 may perform format transformation on the initial image information, and then display on the electronic device 10 according to the transformed image information. Furthermore, the electronic device 10 may also receive a control signal of an operation performed by the user according to the transformed image information, and provide the control signal to the electronic device 12 through the bridge device 11 to control the electronic device 12.

In detail, the electronic device 10 includes a display 100, a processor 101, and a memory 102. The display 100 may be configured to display an image. For example, the display 100 may be a liquid crystal display, a light emitting diode display, an organic light emitting diode display, a mini LED display, a micro LED display, a plasma display, an electronic paper display, a projector display or other suitable displays, but not limited thereto.

The memory 102 stores an application App 1. In this embodiment, the application App 1 stored in the memory 102 may include a transmission module 103, a control module 104, and an audiovisual module 105, the functions of which will be described in detail later. For example, the memory 102 may be any type of fixed or movable random access memory (RAM), read-only memory (ROM), flash memory, hard disk drive (HDD), solid state drive (SSD), similar components or a combination of the above components, and may be configured to store multiple modules or various applications that are to be executed by the processor 101.

The processor 101 is coupled to the display 100 and the memory 102. The processor 101 may control the display 100 to display. The processor 101 may access the memory 102 and execute the application App 1 stored in the memory 102 to transform the initial image information into the transformed image information and control the display 100 to display according to the transformed image information. Furthermore, the processor 101 may also execute the application App1 to receive the control signal generated by the user according to the transformed image information and provide the control signal to the electronic device 12 through the bridge device 11 for control.

For example, the processor 101 may be a central processing unit (CPU), a programmable general-purpose or special-purpose micro control unit (MCU), a microprocessor, a digital signal processor (DSP), a programmable controller, an application specific integrated circuit (ASIC), a graphics processing unit (GPU), an arithmetic logic unit (ALU), a complex programmable logic device (CPLD), a field programmable gate array (FPGA), any other type of integrated circuit, a state machine, a processor based on advanced RISC machine (ARM), similar components or a combination of the above components. In addition, the processor 101 may be designed and realized using a hardware description language (HDL) or other digital circuit designs known to those with ordinary knowledge in the art, but not limited thereto.

In detail, the processor 101 may execute the transmission module 103 to perform data transmission between the electronic device 10 and the bridge device 11, which may include transmission of the initial image information, the control signal or other data required for display or control. In addition, the processor 101 may execute the control module 104 to read or receive the control signal generated by the user according to the transformed image information, and provide the control signal to the electronic device 12 through the bridge device 11 for control. Finally, the processor 101 may execute the audiovisual module 105 to transform the received initial image information with the first format into the transformed image information with the second format which is compatible to the display 100. In some embodiments, the processor 101 may also adaptively perform transformation according to the user's instructions or other display conditions to generate the transformed image information.

FIG. 2A is a flowchart of a control method according to an embodiment of the disclosure. The control method shown in FIG. 2A may be executed by the electronic system 1 shown in FIG. 1. Therefore, please refer to FIG. 1 and FIG. 2A to better understand the control method described in the following paragraphs.

The control method shown in FIG. 2A includes steps S20 to S22. In step S20, the electronic device 10 may receive the initial image information from the electronic device 12 (that is, external electronic device) through the bridge device 11. In step S21, the electronic device 10 executes the audiovisual module 105 to transform the initial image information with the first image format into the transformed image information with the second image format, and the transformed image information is displayed on the display 100 of the electronic device 10. In step S22, the electronic device 10 executes the control module 104 to receive the control signal for operating the transformed image information, and provide the control signal to the electronic device 12 through the bridge device 11 (that is, external electronic device).

In an embodiment, the electronic device 10 of the electronic system 1 may be a computer device, and the electronic device 12 may be a smart phone. The bridge device 11 is coupled to the image output port of the electronic device 12 to acquire the initial image information from the electronic device 12. In this way, in step S20, the electronic device 10 may receive the initial image information with a mobile phone image format from the electronic device 12 through the bridge device 11. In step S21, the electronic device 10 may establish a coordinate transformation relationship between the initial image information and the transformed image information to transform at least one of a display range, a resolution, and a display direction in the initial image information. For example, the processor 10 may scale or crop the initial image information to set the resolution or image range of the transformed image information. Alternatively, the processor 10 may determine the display direction of the initial image information to adaptively transform the display direction to a direction suitable for the display 100 to display. In addition, the initial image information may include black areas generated when transformed to standard video specifications, and the processor 10 may determine that the black areas are invalid areas and set image boundaries that exclude the invalid areas so as to prevent the user from operating in the invalid areas.

Then, in step S22, the user may operate on the display 100 of the electronic device 10 according to the screen displayed by the transformed image information to generate a control signal to control the electronic device 12. For example, the user may use a mouse to click on a first coordinate of the screen displayed by the display 100 in the transformed image information.

The processor 101 may calculate a second coordinate in the initial image information corresponding to the first coordinate in the transformed image information according to the coordinate transformation relationship between the initial image information and the transformed image information established in step S21. The processor 101 may provide the second coordinate and the control signal to the electronic device 12 through the bridge device 11 for control.

For example, according to the control method shown in FIG. 2A, the user may watch the screen displayed by the display 100 of the electronic device 10 and directly click on the displayed screen, and then the processor 101 may generate the control signal according to the coordinate transformation relationship to correctly control the electronic device 12, thereby effectively improving the convenience in operation.

In one example, the electronic device 12 may operate on an Android operating system. Thus, an image may be acquired from the image output port of the electronic device 12 through the bridge device 11 and provided to the electronic device 10. That is, the function of watching and controlling the image of the electronic device 12 may be provided to the electronic device 10. In this way, the disclosure effectively prevents the electronic device 12 from enabling the developer option or enabling the USB debugging function through the Android Debug Bridge (ADB) command, and effectively avoids possible security or information risks for the electronic device 12.

In another example, after the bridge device 11 acquires an image from the electronic device 12, in addition to providing the function of watching and controlling the electronic device 12 to the electronic device 10, the bridge device 11 may provide the function of watching the electronic device 12 to another coupled external display device (not shown in FIG. 1) to share and display the image. In this way, the external display device may acquire the initial image information provided by the electronic device 12 through the bridge device 11 for display.

Although the electronic system 1 in FIG. 1 only shows one bridge device 11 and one electronic device 12 that provides the initial image information, the disclosure is not limited thereto. In an embodiment, the bridge device 11 may be coupled to a plurality of electronic devices 12, and all the electronic devices 12 may provide the initial image information to the bridge device 11. The bridge device 11 has a switch circuit to provide one or more pieces of initial image information to the electronic device 10 according to the control of the electronic device 10 so that the electronic device 10 may select one of the electronic devices 12 for watching and control through the bridge device 11.

Alternatively, in an embodiment, the electronic device 10 may be connected to a plurality of bridge devices 11, and the bridge devices 11 may be respectively connected to the corresponding electronic devices 12 for the electronic device 10 to acquire the function of watching and controlling the corresponding electronic device 12 through each bridge device 11. In this way, each bridge device 11 may provide the initial image information of the corresponding electronic device 12 to the electronic device 10, and the electronic device 10 may select one or more bridge devices 11 for display.

In addition, in an embodiment, the electronic device 10 may be connected to a plurality of bridge devices 11, and each bridge device 11 may be connected to one or more corresponding electronic devices 12, which also falls within the scope of the disclosure.

In summary, according to the electronic device, electronic system, and control method of the disclosure, the user may watch the initial image information provided by other electronic devices on the electronic device without changing the user setting of the electronic device. In addition, the user may provide a control signal on the electronic device that the user is watching to directly control the external electronic device through the bridge device and the application. Therefore, the disclosure not only eliminates complicated setting procedures and effectively improves the convenience in watching and operation but also effectively protects user information.

FIG. 2B is a flowchart of a control method according to an embodiment of the disclosure. Since the control method shown in FIG. 2B is similar to the control method shown in FIG. 2A, the same steps are denoted by the same reference numerals, and for the descriptions thereof, please refer to the relevant paragraphs above, which will not be repeated hereinafter. The control method shown in FIG. 2B may be executed by the electronic system 1 shown in FIG. 1. Therefore, please refer to FIG. 1 and FIG. 2B to better understand the control method described in the following paragraphs.

In the control method shown in FIG. 2B, step S22 includes steps S23 and S24. In step S23, the electronic device 10 executes the control module 104 to receive a control operation for operating the transformed image information, wherein the control operation may be input by at least one of input devices such as a keyboard, a mouse, and a touch device. In step S24, the electronic device 10 may provide a corresponding control command to the electronic device 12 through the bridge device 11 according to control mapping information.

In an embodiment, the processor 101 may execute the control module 104 to pre-create the control mapping information so as to record the corresponding relationship between the control operation and the control command. In this way, when the electronic device 10 receives the control operation such as a long-press event, a fast double-click event, a drag event, a multi-finger touch event, a rotation manipulation event, and a mouse wheel event in step S23, the processor 101 may determine the control operation in step S23 and look up the control mapping information according to the control operation in step S23 to determine the corresponding control command, and provide the control command to the electronic device 12 through the bridge device 11.

Therefore, through the pre-created control mapping information, the user may determine the corresponding relationship between the control operation and the control command. In an embodiment, when the user uses the keyboard to generate the control operation on the electronic device 10, the control operation may be mapped to the control operation for a touch panel or other different input interfaces of the electronic device 12. In other words, by creating the control mapping information, the user may map the control operation to control signals generated by various input interfaces, thereby effectively improving the scalability and convenience of use of the electronic device 1 and the control method.

In an embodiment, the initial image information displayed by the electronic device 12 has a command receiving interface, and the processor 101 may execute the control module 104 to pre-establish the corresponding relationship between the control operation and the command receiving interface, and record the corresponding relationship in the control mapping information. In this way, when the electronic device 10 receives the control operation in step S23, the electronic device 10 may recognize the control operation and look up the control mapping information according to the type of the control operation to determine the command receiving interface corresponding to the control operation and accordingly provide the control signal that triggers the command receiving interface to the bridge device 11 to be transmitted to the electronic device 12.

For example, the command receiving interface may be a touch operation button in the initial image information. When the user directly operates the electronic device 12, the user may directly touch the displayed command receiving interface for control. When the initial image information is provided to the electronic device 10, the user may create the control mapping information on the electronic device 10 to bind the specific control operation to trigger the touch operation button, and store the corresponding relationship in the control mapping information. Therefore, the pre-created control mapping information may not only establish the relationship between the control operation and the control signal but also map the control operation to the command receiving interface in the initial image information so that the user may easily operate the electronic device 12 according to the control mapping information created by the existing input device on the electronic device 10.

FIG. 3A is a schematic diagram of an electronic system 3a according to an embodiment of the disclosure. The electronic system 3a shown in FIG. 3A is similar to the electronic system 1 shown in FIG. 1, except that the bridge device 11 in FIG. 1 is replaced by a bridge device 31a in FIG. 3A. Therefore, the same components are denoted by the same reference numerals, and for the descriptions thereof, please refer to the relevant paragraphs above, which will not be repeated hereinafter.

A data transmission module 110 and an audiovisual acquisition module 112 are stored in the bridge device 31a. In this embodiment, the bridge device 31a may be coupled to the image output port of the electronic device 12, and execute the data transmission module 110 to perform data transmission and execute the audiovisual acquisition module 112 to acquire the initial image information from the image output port. In this embodiment, since the bridge device 31a of the electronic system is not provided with a control operation module, the bridge device 31a cannot share the control signal provided by the electronic device 10 with the electronic device 12. However, by executing the data transmission module 110 and the audiovisual acquisition module 112, the bridge device 31a may still perform audiovisual data transmission.

Therefore, in the electronic system 3a, by plugging the bridge device 31a into the image output port of the electronic device 12 and executing the application App 1 on the electronic device 10, the user may acquire the image of the electronic device 12 and watch it on the electronic device 10 without changing the user setting of the electronic device 12, which effectively improves the convenience of use.

FIG. 3B is a schematic diagram of an electronic system 3b according to an embodiment of the disclosure. The electronic system 3b shown in FIG. 3B is similar to the electronic system 1 shown in FIG. 1, except that the bridge device 11 and the electronic device 12 in FIG. 1 are replaced by a bridge device 31b and an electronic device 32b in FIG. 3A. Therefore, the same components are denoted by the same reference numerals, and for the descriptions thereof, please refer to the relevant paragraphs above, which will not be repeated hereinafter.

In this embodiment, the electronic device 32b includes a display 320, a processor 321, and a memory 322, and the memory 322 stores an application App2. The application App2 may include a transmission module 323, a control module 324, and an audiovisual module 325. The display 320, the processor 321, and the memory 322 in the electronic device 32b may be similar to the display 100, the processor 101, and the memory 102 in the electronic device 10, respectively. The application App1 may be similar to or the same as the application App2. In other words, the application App2 is also stored in the electronic device 32b.

In this embodiment, the bridge device 3 lb stores a data transmission module 110 and a control sharing module 111. In this embodiment, the bridge device 3 lb may execute the data transmission module 110 to perform data transmission and execute the control sharing module to share the control signal provided by the electronic device 10 with the electronic device 32b.

For the electronic system 3b as a whole, since the application App2 is stored in the electronic device 32b, the transmission module 323, the control module 324, and the audiovisual module 325 may be executed through the processor 321. In this way, the electronic device 32b may execute the audiovisual module 325 and the transmission module 323 to acquire the initial image information and transmit it to the bridge device 3 lb. Therefore, the image output port may not be necessary for the electronic device 32b, and even if the bridge device 3 lb is not coupled to the image output port of the electronic device 32b, the electronic system 3b may still transmit the initial image information to the bridge device 3 lb by using the electronic device 32b execute the transmission module 323 and the audiovisual module 325. In addition, the bridge device 3 lb does not need to be provided with the audiovisual acquisition module. Therefore, the requirement for hardware of the electronic system 3b may be effectively lowered.

FIG. 3C is a schematic diagram of an electronic system 3c according to an embodiment of the disclosure. The electronic system 3c shown in FIG. 3C is similar to the electronic system 1 shown in FIG. 1 and the electronic system 3b shown in FIG. 3B. Therefore, the same components are denoted by the same reference numerals, and for the descriptions thereof, please refer to the relevant paragraphs above, which will not be repeated hereinafter.

In this embodiment, the electronic device 32b stores the application App2, and the electronic device 10 stores the application App 1. The electronic device 32b and the electronic device 10 are connected through the bridge device 11. In this way, the function of sharing the image and controlling between the electronic devices 10 and 32b may be a bidirectional operation. That is, by using the electronic device 32b to execute the transmission module 323 and the audiovisual module 325, the user may select to share the initial image information from the electronic device 32 to the electronic device 10. On the other hand, by using the electronic device 10 to execute the transmission module 103 and the audiovisual module 105, the user may also share the initial image information with the electronic device 32b.

It goes without saying that a person with ordinary knowledge in the field may combine the above-described embodiments according to different user and system requirements to carry out adaptive design and adjustment. For example, the operations of steps S23 and S24 in FIG. 2B may also include the operation of step S21 in FIG. 2A. Therefore, when the user uses the mouse to click on the screen of the display 100 according to the transformed image information, the user may use the keyboard at the same time to generate a control operation and map it to a control command. In other words, in addition to the coordinate transformation of mouse clicking, the electronic device 10 may also map the control operation input by the keyboard to a control command at the same time to effectively improve the convenience of use.

FIG. 4 is a schematic diagram of a screen IMG displayed by the display 100 according to the transformed image information according to an embodiment of the disclosure. The screen IMG includes an image area 40 and a menu area 41. The image area 40 includes a screen obtained by transforming the initial image information for the user to operate in the image area 40 through the input device. The menu area 41 includes a plurality of control menus for the user to operate.

In detail, the initial image information displayed in the image area 40 may include a plurality of command receiving interfaces. Take the command receiving interface 400 as an example, it may be a command receiving interface for direction control, and the user may create the control mapping information in the electronic device 10 to bind the command receiving interface 400 to a specific button operation, and display a prompt image 401 of the button operation on the command receiving interface 400 to be easily seen by the user.

Furthermore, the menu area 41 may include a plurality of menus for the user to operate and select the source that provides the initial image information, the device that displays the image, the resolution of the displayed image, whether to map the control operation according to the control mapping information, whether to set or create the control mapping information, and so on. Take the menu 410 as an example, when the user clicks on the menu 410, the user may connect to the bridge device 11 by executing App1, and select the image source for display in the menu 410.

In summary, according to the electronic device, electronic system, and control method of the disclosure, the user may watch the initial image information provided by other electronic devices on the electronic device without changing the user setting of the electronic device. In addition, the user may provide a control signal on the electronic device that the user is watching to directly control the external electronic device through the bridge device and the application. Therefore, the disclosure not only eliminates complicated setting procedures and effectively improves the convenience in watching and operation but also effectively protects user information.

What is claimed is:

1. An electronic device, comprising:
a display;
a memory storing an audiovisual module and a control module; and
a processor receiving initial image information from an external electronic device through a bridge device, the processor being coupled to the display and the memory,
wherein the processor executes the audiovisual module to transform the initial image information with a first image format into transformed image information with a second image format, the processor controls the display to display according to the transformed image information, and the second image format is compatible to the display, and
the processor executes the control module to receive a control signal for operating the transformed image information, and provide the control signal to the external electronic device through the bridge device.

2. The electronic device according to claim 1, wherein the control signal received by the processor corresponds to a first coordinate in the transformed image information, the processor calculates a second coordinate in the initial image information corresponding to the first coordinate in the transformed image information according to a coordinate transformation relationship established by the initial image information and the transformed image information, and the processor provides the control signal and the second coordinate to the bridge device.

3. The electronic device according to claim 1, wherein the processor executes the control module to receive a control operation input through at least one of a keyboard, a mouse, and a touch device.

4. The electronic device according to claim 1, wherein the initial image information comprises a command receiving interface, and the processor executes the control module to set control mapping information so as to record a corresponding relationship between the command receiving interface and a control operation in the control mapping information,
wherein the processor executes the control module to provide the control signal that triggers the command receiving interface to the bridge device according to the control mapping information when receiving the control operation.

5. The electronic device according to claim 1, wherein the processor executes the audiovisual module to transform at least one of a display range, a resolution, and a display direction in the first image format of the initial image information.

6. The electronic device according to claim 1, wherein the memory further stores a transmission module, and the processor executes the transmission module to perform data transmission with the bridge device.

7. An electronic system, comprising:
a first bridge device;
a first electronic device coupled to the first bridge device, wherein the first electronic device receives initial image information through the first bridge device, and the first electronic device comprises:
a display;
a memory storing a first audiovisual module and a control module; and
a processor coupled to the display and the memory; and
a second electronic device coupled to the first bridge device, wherein the second electronic device outputs the initial image information to the first bridge device,
wherein the processor of the first electronic device executes the first audiovisual module to transform the initial image information with a first image format into transformed image information with a second image format, the processor controls the display to display according to the transformed image information, and the second image format is compatible to the display, and
the processor of the first electronic device executes the control module to receive a control signal for operating the transformed image information, and provide the control signal to the second electronic device through the first bridge device.

8. The electronic system according to claim 7, wherein the second electronic device comprises an image output port, and the first bridge device is coupled to the image output port of the second electronic device,
wherein the first bridge device stores an audiovisual acquisition module, and the first bridge device executes the audiovisual acquisition module to acquire the initial image information from the second electronic device and provide the initial image information to the first electronic device.

9. The electronic system according to claim 8, wherein the first bridge device further stores:
a data transmission module, wherein the first bridge device executes the data transmission module to transmit data between the first electronic device and the second electronic device; and
a control sharing module, wherein the first bridge device executes the control sharing module to provide the control signal provided by the first electronic device to the second electronic device.

10. The electronic system according to claim 7, wherein the second electronic device stores a second audiovisual module, and the second electronic device executes the second audiovisual module to provide the initial image information to the first bridge device.

11. The electronic system according to claim 7, wherein the control signal received by the processor of the first electronic device corresponds to a first coordinate in the transformed image information, the processor calculates a second coordinate in the initial image information corresponding to the first coordinate in the transformed image information according to a coordinate transformation relationship established by the initial image information and the transformed image information, and the processor provides the control signal and the second coordinate to the first bridge device.

12. The electronic system according to claim 7, wherein the processor of the first electronic device executes the control module to receive a control operation input through at least one of a keyboard, a mouse, and a touch device.

13. The electronic system according to claim 12, wherein the initial image information comprises a command receiving interface, and the processor of the first electronic device executes the control module to set control mapping information so as to record a corresponding relationship between the command receiving interface and the control operation in the control mapping information,
wherein the processor executes the control module to provide the control signal that triggers the command receiving interface to the first bridge device according to the control mapping information when receiving the control operation so as to operate the second electronic device.

14. The electronic system according to claim 7, wherein the processor of the first electronic device executes the first audiovisual module to transform at least one of a display range, a resolution, and a display direction in the first image format of the initial image information.

15. The electronic system according to claim 7, wherein the memory of the first electronic device further stores a transmission module, and the processor executes the transmission module perform data transmission with the first bridge device.

16. The electronic system according to claim 7, further comprising an external display device coupled to the first bridge device for the external display device to display according to the initial image information.

17. The electronic system according to claim 7, further comprising:
a second bridge device; and
a third electronic device coupled to the second bridge device,
wherein the first electronic device displays and controls at least one of the second electronic device and the third electronic device through the first bridge device and the second bridge device.

18. The electronic system according to claim 7, further comprising:
a third electronic device coupled to the first bridge device, wherein the first electronic device displays and controls one of the second electronic device and the third electronic device through the first bridge device.

19. A control method for controlling an electronic device to display, the control method comprising:
receiving initial image information from an external electronic device through a bridge device;
executing an audiovisual module by the electronic device to transform the initial image information with a first image format into transformed image information with a second image format, and enabling a display of the electronic device to display according to the transformed image information, wherein the second image format is compatible to the display; and
executing a control module by the electronic device to receive a control signal for operating the transformed image information, and providing the control signal to the external electronic device through the bridge device.

20. The control method according to claim 19, wherein the control signal received by the electronic device corresponds to a first coordinate in the transformed image information, and executing the control module by the electronic device to receive the control signal for operating the transformed image information, and providing the control signal to the external electronic device through the bridge device comprises:
calculating a second coordinate in the initial image information corresponding to the first coordinate in the transformed image information according to a coordinate transformation relationship established by the initial image information and the transformed image information, and providing the control signal and the second coordinate to the bridge device.

21. The control method according to claim 19, comprising executing the control module to receive a control operation input through at least one of a keyboard, a mouse, and a touch device.

22. The control method according to claim 19, wherein the initial image information comprises at least one command receiving interface, and the control method further comprises:
executing the control module by the electronic device to set control mapping information so as to record a corresponding relationship between the command receiving interface and a control operation in the control mapping information; and
executing the control module by the electronic device to provide the control signal that triggers the command receiving interface to the bridge device according to the control mapping information when receiving the control operation.

23. The control method according to claim 19, wherein executing the audiovisual module by the electronic device to transform the initial image information with the first image format into the transformed image information with the second image format comprises:
executing the audiovisual module by the electronic device to transform at least one of a display range, a resolution, and a display direction in the first image format of the initial image information.

24. The control method according to claim 21, further comprising executing a transmission module by the electronic device to perform data transmission with the bridge device.
